(19) United States
(12) Patent Application Publication
(10) Pub. No.: US 2024/0359637 A1
(43) Pub. Date: Oct. 31, 2024

(54) SENSOR MODULE COMPRISING A WEATHERSTRIP ARRANGEMENT, A ROOF MODULE AND A MOTOR VEHICLE

(71) Applicant: Webasto SE, Stockdorf (DE)

(72) Inventor: Nikolaus LINNER, Stockdorf (DE)

(21) Appl. No.: 18/644,474

(22) Filed: Apr. 24, 2024

(30) Foreign Application Priority Data
Apr. 27, 2023 (DE) 10 2023 110 944.8

(51) Int. Cl. B60R 11/04; B60R 11/00; B60R 13/06; G01S 7/02; G01S 13/931; H04N 23/51; H04N 23/52

(52) U.S. Cl. CPC B60R 11/04; B60R 13/06; B60R 2011/004; B60R 2011/0082; G01S 7/027; G01S 2013/9323; G01S 2013/9324; G01S 2013/93273; H04N 23/51; H04N 23/52

(57) ABSTRACT

A sensor module, for being fitted on a roof module and/or on a motor vehicle, has at least one retractable and extendable environment sensor and has a weatherstrip arrangement, which forms a separating barrier between a wet area, from which it is possible to drain liquid from the sensor module, and a dry area. The weatherstrip arrangement has at least one flexure bearing and/or a folding joint and/or a living hinge.

### CROSS-REFERENCE TO RELATED APPLICATION(S)

This application claims the benefit of German patent application no. 10 2023 110 944.8 filed on Apr. 27, 2023, which is incorporated herein by reference in its entirety.

### TECHNICAL FIELD

The invention relates to a sensor module for being fitted on a roof module and/or on a motor vehicle. Furthermore, the invention relates to a roof module having such a sensor module and to a motor vehicle having such a sensor module and/or a roof module.

### BACKGROUND

Sensor modules are increasingly being used as part of the increasing automation of motor vehicles. In order to enable autonomous or semi-autonomous control of the motor vehicle, a plurality of environment sensors (e.g., lidar sensors, radar sensors, (multi) cameras, etc. together with other (electrical) components) are used which, for example, are integrated into such a sensor module, record the environment around the motor vehicle and determine, for example, a respective traffic situation from the recorded environmental data.

Furthermore, roof modules are known in the prior art and are already widely used in vehicle construction. For example, roof modules are prefabricated as separate function modules and connected to a roof frame structure (which is part of the body structure) on the assembly line. The roof module forms at least sections of a roof skin of the vehicle roof on its outer surface, said roof skin preventing moisture or airflow from permeating the vehicle interior. The roof skin is formed by one or several panel components, which can be made of a stable material, for example painted sheet metal or painted or colored plastic. The roof module can be part of a rigid vehicle roof or part of an openable roof module.

Roof modules which are provided with a plurality of environment sensors are also known as roof sensor modules (RSM). The known environment sensors transmit or receive corresponding electromagnetic signals, for example laser beams or radar beams, whereby a data model of the vehicle environment is generated by a corresponding signal evaluation and can be used for vehicle control. In order to protect the environment sensors from harmful environmental influences, such as moisture and air flow, the environment sensors are usually installed in one or several housings that define a dry area of the roof module which moisture cannot permeate.

Disposing sensor modules and/or environment sensor in an opening of a panel component of a motor vehicle and/or a roof module so as to be retractable and extendable is known. This meets aesthetic aspects, as the sensor module is not always visible. Furthermore, the sensor modules are protected from environmental influences when retracted.

### SUMMARY

However, there is the problem that moisture and/or wetness can permeate an opening in which the sensor module is disposed, particularly during the retraction and extension of the sensor module. A sensor module that is retractable and extendable must therefore have a water management system or water drainage management system. However, a seal that is often used, which is disposed around the opening, is not always completely leak-proof in both end positions. In addition, during the movement of the sensor module and/or the environment sensor, a gap can be formed between the opening and the sensor module and/or the environment sensor through which moisture and/or humidity and/or dirt can enter. The displacement mechanism of the sensor module and other components should not be exposed to moisture and/or dirt. In the prior art, a further sealing barrier is provided for this purpose, which moves with the sensor module and/or the environment sensor during retraction and extension, and which forms a barrier between a wet area, into which the moisture and/or dirt enters, and a dry area. Such a sealing barrier is formed, for example, by a water pocket made of a textile and/or an elastic plastic, such as a rubber bellows.

For one thing, the water pocket is circumferentially attached to an edge area of the opening. For another thing, it is attached to the movable sensor module and/or environment sensor, usually to a sensor housing edge. This results in several challenges. For one thing, folds which block the draining of moisture and/or dirt can form in the water pocket. Furthermore, handling during installation is very complex and difficult, as the flexibly movable water pocket has many degrees of mobility. Some displacement mechanisms also require a large excess length of the water pocket, so that in some positions of the sensor module and/or the environment sensor it is not possible to discharge moisture and/or dirt. In addition, some variants of the water pocket require a water outlet to be integrated into the water pocket, which requires a great deal of effort and elaborate sealing.

It is an object of the present invention to propose a sensor module with an improved weatherstrip arrangement.

The object is attained by a sensor module for being fitted on a roof module and/or on a motor vehicle, the sensor module having at least one retractable and extendable environment sensor and having a weatherstrip arrangement, which forms a separating barrier between a wet area, from which it is possible to drain liquid from the sensor module, and a dry area, characterized in that the weatherstrip arrangement has at least one flexure bearing and/or a folding joint and/or a living hinge. Furthermore, the object is attained by a roof module having at least one sensor module of this kind and/or by a motor vehicle having at least one roof module of this kind and/or having at least one sensor module of this kind.

Advantageous embodiments of the invention include the following.

The weatherstrip arrangement can include at least two surface elements which are rigid and which are connected to each other so as to be flexible and/or moveable via the at least one flexure bearing and/or the at least one folding joint and/or the at least one living hinge.

The at least two surface elements can be moveable relative to each other around at least one rotation axis.

The weatherstrip arrangement can be a two-component injection-molded part and has a support layer, the at least two surface elements being formed by applying an injection molding material in particular onto the entire support layer, the at least one flexure bearing and/or the at least one folding joint and/or the at least one living hinge being formed by a section of the support layer.

The weatherstrip arrangement can form a water pocket which defines the wet area.

The sensor module can have a sensor housing in which the at least one environment sensor is disposed, at least sections of the sensor housing being coupled and/or connected to the weatherstrip arrangement so as to transmit movement, in particular in such a manner that the at least one weatherstrip arrangement moves along when the at least one environment sensor is retracted and extended.

The weatherstrip arrangement can have at least two side elements which are formed by a textile material and/or by a flexible material and/or by a rubber material.

The at least two surface elements can be connected to the at least two side elements such that they form at least one trough-shaped internal space which defines the wet area.

For draining the liquid entering the wet area, the weatherstrip arrangement can have at least one outlet.

The at least one environment sensor can have a lidar sensor and/or a radar sensor and/or a camera sensor and/or a multi-camera sensor and/or an ultrasonic sensor.

A roof module, for forming a vehicle roof on a motor vehicle, can include a panel component, which forms at least sections of a roof skin of the vehicle roof, and the roof module including an opening, in which at least one sensor module described above is disposed so as to be retractable and extendable, the environment sensor being configured so as to be able to send and/or receive electromagnetic signals to detect the vehicle environment.

The opening can be essentially rectangular, the weatherstrip arrangement being attached to at least two opposite edges of the opening.

A motor vehicle can include a sensor module described above and/or at least one roof module described above.

The invention relates to all combinations comprising at least two features disclosed in the description, the claims and/or the figures. The explanations given for the sensor module equivalently relate to the roof module according to the invention and/or to the motor vehicle according to the invention without being mentioned redundantly in their context. In particular, linguistically common rephrasing and/or an analogous replacement of respective terms within the scope of common linguistic practice, in particular the use of synonyms backed by the generally recognized linguistic literature, are comprised by the content of the disclosure at hand without every variation having to be expressly mentioned.

The sensor module according to the invention is intended for being fitted on a roof module and/or on a motor vehicle. The sensor module has at least one retractable and extendable environment sensor. Particularly preferably, the sensor module has a displacement mechanism by means of which the at least one environment sensor is retractable and extendable. The design of such a displacement mechanism of this kind is basically arbitrary. Particularly preferably, the environment sensor can be displaced by means of an electric motor. The sensor module has a weatherstrip arrangement which forms a separating barrier between a wet area, from which it is possible to drain and/or discharge liquid and/or moisture and/or dirt from the sensor module, in particular from the environment sensor, and a dry area. The dry area is protected from liquid and/or moisture and/or dirt by means of the separating barrier. The weatherstrip arrangement has at least one flexure bearing and/or a folding joint and/or a living hinge.

For example, liquid and/or moisture and/or dirt and/or water and/or other foreign particles can enter the wet area, for example, from a vehicle environment, as the at least one environment sensor is disposed so as to be retractable and extendable on the motor vehicle. By means of the weatherstrip arrangement, the liquid and/or the moisture and/or the dirt and/or the water can be drained from the wet area. The at least one environment sensor and/or a displacement mechanism and/or other components of the sensor module and/or of the roof module and/or of the motor vehicle can be disposed in the dry area. In principle, however, the at least one environment sensor can also be partially or completely disposed in the wet area, protected by a housing.

In the present invention, a flexure bearing is an area of the weatherstrip arrangement that allows relative movement between two rigid body areas of the weatherstrip arrangement by bending. In the present invention, a folding joint is an area of the weatherstrip arrangement that allows relative movement between two rigid body areas of the weatherstrip arrangement by folding around an axis. In the present invention, an integral hinge of the weatherstrip arrangement is referred to as a living hinge. The living hinge is preferably represented by a thin and/or material-weakened and/or material-weak and/or flexible hinge. The living hinge is preferably made of the same material as the weatherstrip arrangement. The living hinge preferably connects two rigid parts and/or elements of the weatherstrip arrangement in a movable and/or articulated manner. The flexure bearing and/or folding joint and/or living hinge is preferably formed by at least partial thinning and/or by at least partial cutting out or cutting in and/or by at least partial removal of a material of the weatherstrip arrangement. Alternatively, the flexure bearing and/or folding joint and/or living hinge can also be formed by applying material to certain areas of or over a large area of a support layer of the weatherstrip arrangement and by partially omitting a section which forms the flexure bearing and/or folding joint and/or living hinge. The flexure bearing and/or folding joint and/or living hinge preferably extends along a line and/or has a linear design, and preferably separates two rigid areas of the weatherstrip arrangement from one another. The direction of extension of the flexure bearing and/or of the folding joint and/or of the living hinge is preferably parallel to a bending line and/or to a bending axis of the flexure bearing and/or of the folding joint and/or of the living hinge.

In particular if the at least one environment sensor is retracted or extended, rainwater or other moisture (liquid) may enter the opening of the roof module. This liquid can be safely drained by means of the weatherstrip arrangement according to the invention at all times, such that liquid can be prevented from entering the roof module (for example, a dry area) or the roof space of the vehicle. “At least one environment sensor” means that the roof module can comprise one or several environment sensors.

One advantage of the sensor module according to the invention is that moisture and/or water and/or dirt entering through the weatherstrip arrangement can flow away from the sensor module easily and unhindered. In particular, the weatherstrip arrangement no longer causes folds to form, which would prevent such an unhindered discharge and/or flow. This is achieved in particular by the weatherstrip arrangement having at least one flexure bearing and/or a folding joint and/or a living hinge, which prevents uncontrolled folding and/or creasing. Particularly preferably, an outlet can be disposed off-tool on the weatherstrip arrangement or be integrated into the weatherstrip arrangement using a tool without further processing or assembly. In particular, the weatherstrip arrangement no longer causes folds to form in corner areas of an opening of the roof module and/or of the motor vehicle, in which the sensor module is preferably disposed. In addition, a positioning and/or an arrangement of the individual movable and fixed and/or rigid components of the weatherstrip arrangement is clearly defined based on the clearly determined kinks and/or movement points. As a result, different components of the weatherstrip arrangement can be joined together by simple and preferred process techniques, such as welding or the like.

The roof module according to the invention can form a modular unit, in which elements for autonomous or semi-autonomous driving supported by driving assistance systems are integrated and which can be mounted as a unit on a vehicle carcass by a vehicle manufacturer. Furthermore, the roof module according to the invention can be an entirely fixed roof or be a roof together with a roof opening system. In addition, the roof module can be designed for use in a passenger car or in a commercial vehicle. The roof module can preferably be provided as a modular unit in the form of a roof sensor module (RSM), in which the environment sensors are provided in order to be inserted into a roof frame of a vehicle body as a supplyable modular unit.

In general, the environment sensor of the sensor module of the roof module according to the invention can have various designs and can comprise in particular a lidar sensor, a radar sensor, an optical sensor, such as a camera and/or the like. For example, lidar sensors operate between a wavelength range of 905 nm and approximately 1,550 nm. The material of the roof skin in the see-through area should be transparent for the wavelength range used by the environment sensor and the material should therefore be selected in accordance with the wavelength(s) used by the environmental sensor.

In a preferred embodiment, the weatherstrip arrangement comprises at least two surface elements which are rigid and which are connected to each other so as to be flexible and/or moveable via the at least one flexure bearing and/or the at least one folding joint and/or the at least one living hinge. At present, “rigid” means that each surface element is stiff and/or not elastic, but that said surface elements can be moved relative to one another due to the at least one flexure bearing and/or the at least one folding joint and/or the at least one living hinge. The surface elements can be made of a plastic material, for example. The at least one flexure bearing and/or the at least one folding joint and/or the at least one living hinge is preferably made of the same plastic material as at least one part of the surface elements. Particularly preferably, the surface elements form the main surface of the weatherstrip arrangement. At least one of the surface elements preferably forms at least one bottom element of the weatherstrip arrangement, said bottom element preferably being disposed below the environment sensor, viewed in the direction of a roof module interior. At least one of the surface elements forms a front wall of the weatherstrip arrangement, said front wall being oriented transversely to a viewing direction of the environment sensor and preferably extending parallel to a sensor housing in at least one direction. At least one of the surface elements forms a rear wall of the weatherstrip arrangement, said rear wall being oriented transversely to a viewing direction of the environment sensor and preferably extending parallel to a sensor housing in at least one direction. The at least two surface elements can be formed integrally and be separated from each other only by partial material removal. The partial material removal preferably forms the at least one flexure bearing and/or the at least one folding joint and/or the at least one living hinge. The at least two panel components preferably have a greater thickness relative to the at least one flexure bearing and/or the at least one folding joint and/or the at least one living hinge, so that they have a greater rigidity relative to the at least one flexure bearing and/or the at least one folding joint and/or the at least one living hinge. Because of the at least two surface elements, of which at least one forms a bottom of the weatherstrip arrangement, the water and especially the dirt can flow out of the weatherstrip arrangement easily and unhindered. In particular, the formation of the rigid surface elements prevents undesirable folds from forming, which can occur, for example, if the weatherstrip arrangement is made of a non-rigid textile material.

In a preferred embodiment, the at least two surface elements are moveable relative to each other around at least one rotation axis and/or movement axis and/or buckling axis. The rotation axis and/or movement axis and/or buckling axis extends preferably parallel to a length of the at least one flexure bearing and/or of the at least one folding joint and/or of the at least one living hinge. The at least one flexure bearing and/or the at least one folding joint and/or the at least one living hinge is preferably formed between at least two surface elements so as to be essentially strip-shaped and/or gap-shaped. The at least one flexure bearing and/or the at least one folding joint and/or the at least one living hinge preferably extends over an entire width of the at least two surface elements, so that said surface elements can me moved relative to each other and/or can be kinked.

In a preferred embodiment, the weatherstrip arrangement is a two-component injection-molded part and has a support layer. The at least two surface elements are formed by applying an injection molding material in particular onto the entire support layer. The at least one flexure bearing and/or the at least one folding joint and/or the at least one living hinge is formed by a section of the support layer in which preferably no injection molding material is applied to the support layer. The support layer can be made of the same material as the material applied to form the at least two surface elements. Alternatively, the materials can be different materials. The support layer can be a support film, for example, to sections and/or areas of which material is applied using injection molding in order to form the at least two surface areas. The at least one flexure bearing and/or the at least one folding joint and/or the at least one living hinge is preferably formed as a kink. The at least two surface elements preferably have two components (two-component injection molding), whereas the kinks only have one of the two components.

In a preferred embodiment, the weatherstrip arrangement forms a water pocket which defines the wet area. Thus, the weatherstrip arrangement defines a water bag in which permeating water can be collected and, subsequently, be drained from the sensor module. The water pocket is preferably closed along a circumferential direction and preferably open in the direction of a vehicle exterior and/or a sensor module exterior.

In a preferred embodiment, the sensor module has a sensor housing in which the at least one environment sensor is disposed, at least sections of the sensor housing being coupled and/or connected to the weatherstrip arrangement so as to transmit movement, in particular in such a manner that the at least one weatherstrip arrangement can move along when the at least one environment sensor is retracted and extended. Particularly preferably, the sensor housing is connected to the weatherstrip arrangement via a flat element which is disposed on the sensor module at its one end and which is disposed on the weatherstrip arrangement on its other end. Particularly preferably, the flat element is connected to a surface element of the weatherstrip arrangement. Alternatively, the flat element can also be connected to the flexure bearing and/or the folding joint and/or the living hinge. Particularly preferably, the flat element is connected to the at least one surface element and/or to the at least one flexure bearing and/or to the at least one folding joint and/or to the living hinge so as to be moisture-proof. The flat element can be welded and/or glued to the at least one surface element and/or to the at least one flexure bearing and/or to the at least one folding joint and/or to the living hinge, for example. The flat element preferably forms a part of the sealing barrier. At least parts of the flat element are preferably used to limit the wet area.

In a preferred embodiment, the weatherstrip arrangement has at least two side elements which are formed by a textile material and/or by a flexible material and/or by a rubber material. In the present case, preferably only the side walls of the weatherstrip arrangement are made of a soft material, such as a textile or a similar foldable sheet-like material, said side walls preferably extending essentially parallel to a viewing direction of the environment sensor. Compared to the prior art, the assembly of the side walls made of the textile material is easier; the weatherstrip arrangement has less degrees of mobility because of the rigid surface elements. In addition, the side elements preferably do not affect a water discharge from the sensor module, as the water is collected at the in particular rigid base of the weatherstrip arrangement and is discharged from the sensor module there. This means that folds can form in the side elements when the environment sensor is retracted and extended, but these folds cannot block a water discharge from the weatherstrip arrangement.

In a preferred embodiment, the at least two surface elements are connected to the at least two side elements such that they form at least one trough-shaped internal space which defines the wet area. The side elements are preferably connected to the at least two surface elements in a moisture-proof manner. For example, the side elements can be welded and/or glued to the at least two surface elements.

In a preferred embodiment, the weatherstrip arrangement has at least one outlet for draining the liquid entering the wet area. A preferred outlet can be integrated off-tool into one of the rigid surface elements, in particular welded or glued to one of the surface elements, using a tool without further processing or assembly.

In a preferred embodiment, the at least one environment sensor has a lidar sensor and/or a radar sensor and/or a camera sensor and/or a multi-camera sensor and/or an ultrasonic sensor auf. In principle, other environment sensors not explicitly mentioned here are also conceivable.

The invention also proposes a roof module for forming a vehicle roof on a motor vehicle. The roof module comprises a panel component, which forms at least sections of a roof skin of the vehicle roof. The roof module comprises an opening, in which at least one sensor module according to an embodiment of the invention is disposed so as to be retractable and extendable. The environment sensor can send and/or receive electromagnetic signals to detect the vehicle environment.

In a preferred embodiment, the opening is essentially rectangular, the weatherstrip arrangement being attached to at least two opposite edges of the opening. Particularly preferably, the optional front wall of the weatherstrip arrangement is directly or indirectly connected to a front edge of the opening or directly or indirectly connected to the panel component in the area of the front edge of the opening. The front edge preferably extends transversely to a viewing direction of the environment sensor. Particularly preferably, the optional rear wall of the weatherstrip arrangement is directly or indirectly connected to a rear edge of the opening (in the viewing direction of the environment sensor behind the sensor) or directly or indirectly connected to the panel component in the area of the rear edge of the opening. Particularly preferably, one of the optional side elements of the weatherstrip arrangement is directly or indirectly connected to a right-sided side edge of the opening or is directly or indirectly connected to the panel component in the area of the right-sided side edge of the opening (viewed in the viewing direction of the environment sensor). Particularly preferably, one of the optional side elements of the weatherstrip arrangement is directly or indirectly connected to a left-sided side edge of the opening or directly or indirectly connected to the panel component in the area of the left-sided side edge of the opening (viewed in the viewing direction of the environment sensor).

The roof module can also comprise several openings, several environment sensors and several weatherstrip arrangements (at least one per opening and environment sensor) without departing from the scope of the present invention.

The invention also proposes a motor vehicle which has at least one sensor module according to an embodiment of the invention and/or at least one roof module. The location of the sensor module on the motor vehicle is basically arbitrary.

Particularly preferably, the invention relates to a motor vehicle comprising a vehicle body and at least one roof module according to anyone of the stated embodiments, said roof module being formed disposed on the vehicle body, in particular in a roof area of the vehicle body, as a modular unit.

The embodiments and the illustrative examples described above and yet to be explained below can be formed not only individually but also in any combination without departing from the scope of the present invention. It is also obvious that the embodiments and the illustrative examples described above and yet to be explained below equivalently or at least similarly relate to all explanations regarding the invention without having to be mentioned separately.

### BRIEF DESCRIPTION OF DRAWINGS

Embodiments of the invention are schematically illustrated in the drawings and are described in an exemplary manner hereinafter.

FIG. 1 shows a schematic view of an embodiment of a motor vehicle;

FIG. 2 shows a schematic bottom view of an embodiment of a sensor module in an extended position;

FIG. 3 shows a sectional view of the sensor module shown in FIG. 2;

FIG. 4 shows a schematic bottom view of the embodiment of a sensor module shown in FIG. 2 in a retracted position;

FIG. 5 shows a sectional view of the sensor module shown in FIG. 4; and

FIG. 6 shows a detailed view of an embodiment of a weatherstrip arrangement.

### DETAILED DESCRIPTION

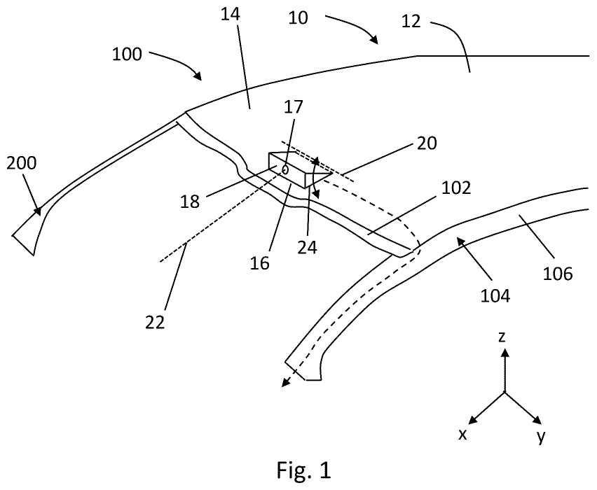

FIG. 1 shows a vehicle roof 100 of a motor vehicle 1000. In the present invention, vehicle roof 100 is formed by a roof module 10. Roof module 10 has a panel component 12 for forming a roof skin 14 of vehicle roof 100. Viewed in a longitudinal vehicle direction x, an opening 16 is located in a front face, central roof area of vehicle roof 100, a sensor module 17 being disposed in said opening 16, said sensor module 17 having at least one environment sensor 18. Viewed in a vehicle width direction y, opening 16 is disposed centrally directly behind a front transverse rail 102, which defines a roof header of motor vehicle 1000. Longitudinal vehicle direction x extends orthogonally to vehicle width direction y. Vehicle width direction y extends orthogonally to a vehicle height direction z. Longitudinal vehicle direction x extends orthogonally to vehicle height direction z.

Roof module 10 is disposed on a roof frame 104 of a vehicle body 200 of motor vehicle 1000 as a modular unit. Roof frame 104 is formed by at least two of transverse rails 102 (front and rear) and by at least two longitudinal rails 106 extending in longitudinal vehicle direction x.

Environment sensor 18 is a lidar sensor, for example. Environment sensor 18 is retractable and extendable, in the present case, displaceable, between a retracted position and an extended position around a rotation axis 20 of environment sensor. In general, environment sensor 18 can also be retracted and extended via a translational and/or rotatory movement. In FIG. 1, environment sensor 18 is shown in the extended position. The displaceability of environment sensor 18 from the retracted position to the extended position and vice versa is preferably provided by means of an electric drive; more general, by means of a displacement mechanism and/or displacement kinematics (not shown).

Environment sensor 18 is configured to detect, for example by means of an evaluation and control unit, a vehicle environment around motor vehicle 1000 by means of electromagnetic signals. To this end, environment sensor 18 is configured to send and/or to receive electromagnetic signals in a field of view extending around an optical axis 22 of environment sensor 18.

To prevent (rain) water, which could cause damage to environment sensor 10 and/or to other electrical components and within the internal space of motor vehicle 1000, from permeating opening 16, roof module 10 has a weatherstrip arrangement 24. When environment sensor 18 is retracted and/or extended, water may enter between (meaning into an edge portion) environment sensor 18 and opening 16 because of the rotational movement around rotation axis 20 of environment sensor 18. Weatherstrip arrangement 24 is preferably configured to gather the water entering through opening 16, such that said water can be drained or discharged from motor vehicle 1000 on the right and left side, viewed in longitudinal vehicle direction x.

This water discharge is indicated by a dashed arrow in FIG. 1. The water is discharged from sensor module 17, for example, along an A-pillar of vehicle body 200 of motor vehicle 1000. In other embodiments, the water can also be discharged via a B-, C- or D-pillar of vehicle body 200.

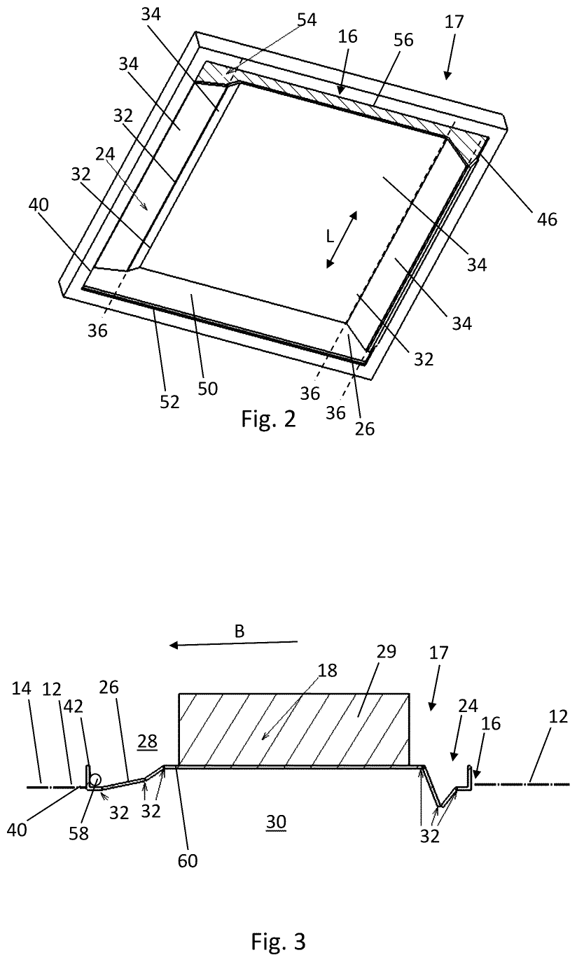

Weatherstrip arrangement 24 forms a separating barrier 26 between a wet area 28, from which it is possible to drain liquid from sensor module 17, and a dry area 30 (see FIG. 2 to 5). In the present case, environment sensor 18 is disposed in wet area 28 so as to be protected from moisture in a sensor housing 29. Weatherstrip arrangement 24 has at least one flexure bearing and/or one folding joint and/or one living hinge 32. According to FIGS. 2 to 5, weatherstrip arrangement 24 has several living hinges 32. It should be noted that the reference sign 32 is also used synonymously for the terms flexure bearing and/or folding joint.

Weatherstrip arrangement 24 comprises at least two surface elements 34, which are formed rigidly and which are connected to each other so as to be flexible and/or moveable via at least one living hinge 32. In the present case, weatherstrip arrangement 24 comprises more than two surface elements 34. Living hinges 32 preferably extend in a longitudinal direction L of weatherstrip arrangement 24. At least two surface elements 34 are moveable relative to each other around at least one rotation axis 36.

One of the at least two surface elements 34 forms a front wall 38 of weatherstrip arrangement 24 which is indirectly connected to a front edge 40 of opening 16 via a support profile 42. Front edge 40 extends transversely to a viewing direction of environment sensor 18. In viewing direction B of environment sensor 18 behind environment sensor 18, a rear wall 44 of weatherstrip arrangement 24 is indirectly connected to a rear edge 46 of opening 16 via a further support profile 48.

Viewed in viewing direction B of environment sensor 18, one side element 50 of weatherstrip arrangement 24 is directly or indirectly connected to a right-sided side edge 52 of opening 16. In viewing direction B of environment sensor 18, a further side element 54 of weatherstrip arrangement 24 is directly or indirectly connected to a left-sided side edge 56 of opening 16. Side elements 50, 54 are made of a textile material and/or of a flexible material and/or of a rubber material.

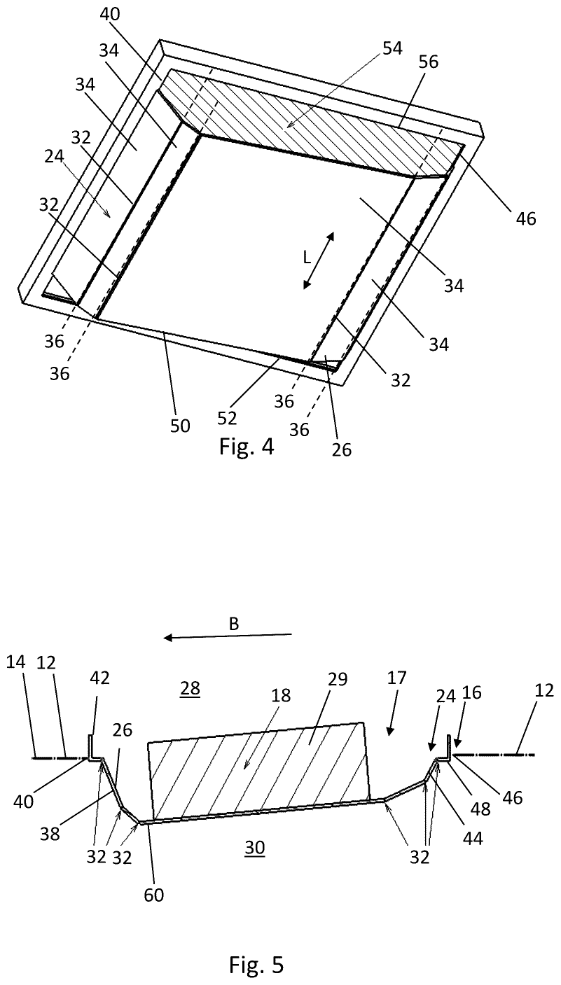

For draining the liquid entering wet area 28, weatherstrip arrangement 24 has at least one outlet 58 auf (see FIG. 5).

Weatherstrip arrangement 24 forms a water pocket 60 by means of which wet area 28 is enclosed or sectioned off in a defined manner.

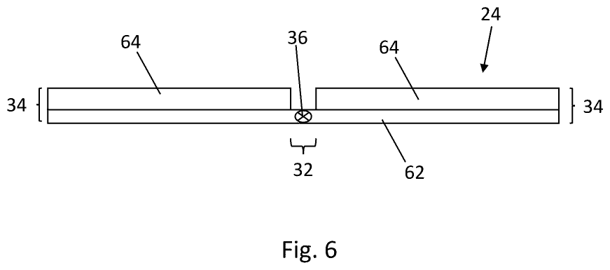

FIG. 6 shows an illustrative example of weatherstrip arrangement 24. In this case, weatherstrip arrangement 24 is formed as a two-component injection-molded part and has a support layer 62. At least two surface elements 34 are formed by applying an injection molding material to the entire support layer 62. At least one living hinge 32 is formed by a material-weakened section, which is determined by the thickness of the support layer 62. A material application 64 is applied to support layer 62 to form surface elements 34. Said material application 64 can be made of the same material as support layer 62 or of a different material than support layer 62. Because of the greater thickness of surface elements 34 compared to support layer 62, surface elements 34 have greater rigidity than living hinge 32. As a consequence, at least sections of weatherstrip arrangement 24 can be moved around rotation axis 36 on living hinge 32.

### LIST OF REFERENCE SIGNS

10 roof module
12 panel component
14 roof skin
16 opening
17 sensor module
18 environment sensor
20 rotation axis
22 optical axis
24 weatherstrip arrangement
26 separating barrier
28 wet area
29 sensor housing dry area
32 living hinge
34 surface element
36 rotation axis
38 front wall
40 front edge
42 support profile
44 rear wall
46 rear edge
48 support profile
50 side element
52 side edge
54 side element
56 side edge
58 outlet
60 water pocket
62 support layer
64 material application
100 vehicle roof
102 transverse rail
104 roof frame
106 longitudinal rail
200 vehicle body
1000 motor vehicle
x longitudinal vehicle direction
y vehicle width direction
z vehicle height direction
L longitudinal direction
B viewing direction

1. A sensor module for being fitted on a roof module and/or on a motor vehicle, the sensor module having at least one retractable and extendable environment sensor and having a weatherstrip arrangement, which forms a separating barrier between a wet area, from which it is possible to drain liquid from the sensor module, and a dry area, wherein the weatherstrip arrangement has at least one flexure bearing and/or a folding joint and/or a living hinge.

2. The sensor module according to claim 1, wherein the weatherstrip arrangement comprises at least two surface elements which are rigid and which are connected to each other so as to be flexible and/or moveable via the at least one flexure bearing and/or the at least one folding joint and/or the at least one living hinge.

3. The sensor module according to claim 2, wherein the at least two surface elements are moveable relative to each other around at least one rotation axis.

4. The sensor module according to claim 2, wherein the weatherstrip arrangement is a two-component injection-molded part and has a support layer, the at least two surface elements being formed by applying an injection molding material in particular onto the entire support layer, the at least one flexure bearing and/or the at least one folding joint and/or the at least one living hinge being formed by a section of the support layer.

5. The sensor module according to claim 1, wherein the weatherstrip arrangement forms a water pocket which defines the wet area.

6. The sensor module according to claim 1, wherein the sensor module has a sensor housing in which the at least one environment sensor is disposed, at least sections of the sensor housing being coupled and/or connected to the weatherstrip arrangement so as to transmit movement.

7. The sensor module according to claim 1, wherein the weatherstrip arrangement has at least two side elements which are formed by a textile material and/or by a flexible material and/or by a rubber material.

8. The sensor module according to claim 2, wherein the at least two surface elements are connected to the at least two side elements such that they form at least one trough-shaped internal space which defines the wet area.

9. The sensor module according to claim 1, wherein for draining the liquid entering the wet area, the weatherstrip arrangement has at least one outlet.

10. The sensor module according to claim 1, wherein the at least one environment sensor has a lidar sensor and/or a radar sensor and/or a camera sensor and/or a multi-camera sensor and/or an ultrasonic sensor.

11. A roof module for forming a vehicle roof on a motor vehicle, the roof module comprising
a panel component, which forms at least sections of a roof skin of the vehicle roof, and the roof module comprising an opening, in which at least one sensor module according to claim 1 is disposed so as to be retractable and extendable, the environment sensor being configured so as to be able to send and/or receive electromagnetic signals to detect the vehicle environment.

12. The roof module according to claim 11, the opening being essentially rectangular, the weatherstrip arrangement being attached to at least two opposite edges of the opening.

13. A motor vehicle comprising a sensor module according to claim 1.

14. A motor vehicle comprising at least one roof module according to claim 11.

15. The sensor module according to claim 1, wherein the sensor module has a sensor housing in which the at least one environment sensor is disposed, at least sections of the sensor housing being coupled and/or connected to the weatherstrip arrangement so as to transmit movement in such a manner that the at least one weatherstrip arrangement moves along when the at least one environment sensor is retracted and extended.
